(19) United States
(12) Patent Application Publication
(10) Pub. No.: US 2026/0025660 A1
(43) Pub. Date: Jan. 22, 2026

(54) Establishment of a Wireless Data Connection

(71) Applicant: Siemens Aktiengesellschaft, München (DE)

(72) Inventor: Andreas Kiepfer, Erlangen (DE)

(73) Assignee: Siemens Aktiengesellschaft, München (DE)

(21) Appl. No.: 18/998,689

(22) PCT Filed: Jul. 14, 2023
(86) PCT No.: PCT/EP2023/069639

§ 371 Date: Jan. 27, 2025

(30) Foreign Application Priority Data
Jul. 28, 2022 (DE) 10 2022 207 781.4

(51) Int. Cl. H04W 12/06; H04W 12/106; H04W 76/11

(52) U.S. Cl. CPC H04W 12/068; H04W 12/106; H04W 76/11

(57) ABSTRACT

Various embodiments of the teachings herein include a device comprising: an interface for wireless data connection; a controllable signal facility to generate an optical or acoustic signal; and a control facility for the interface and for the controllable signal facility. The control facility, to acquire a data connection to a second device carries out a PIN exchange method comprising: generating and storing a PIN for the data connection; emitting the PIN with the signal facility to enable reception by the second device; return reception of the PIN from the second device via the wireless data connection; and acquisition of the data connection only when the received PIN matches the stored PIN.

### CROSS-REFERENCE TO RELATED APPLICATIONS

This application is a U.S. National Stage Application of International Application No. PCT/EP2023/069639 filed Jul. 14, 2023, which designates the United States of America, and claims priority to DE Application No. 10 2022 207 781.4 filed Jul. 28, 2022, the contents of which are hereby incorporated by reference in their entirety.

### TECHNICAL FIELD

The present disclosure relates to wireless data transfer. Various embodiments of the teachings herein include systems with an interface for a wireless data connection and methods for establishing a wireless data connection between a first and a second device with an interface of this type.

### BACKGROUND

For the pairing of Bluetooth devices, in an ideal case, a method is used in which, by means of a PIN, it is ensured that the desired devices are connected to one another. For the connection of a smartphone to a vehicle, for example, a display in the vehicle can show a PIN generated by the vehicle which must be input manually into the smartphone. The smartphone then transfers this PIN to the vehicle, by which it is authenticated. By this means, it is made significantly more difficult for persons outside the vehicle to connect a Bluetooth device to the vehicle.

Some devices have no display and no input capability. In the end-user domain this is, for example, headsets. In many devices in the industrial domain, for reasons of size and/or cost, the installation of display and input capabilities is not possible. In devices of this type, the manner of the pairing as described, with a PIN, cannot be used. An alternative mechanism for the pairing without a PIN functions in such a way that the device to be paired is put into a pairing mode, for example, by pressing a button. After this, the device then accepts all pairing requests from other devices. A disadvantage thereof is that this procedure has a low level of security since every undesirable device in the relatively close vicinity can then also carry out a pairing.

A further alternative mechanism uses a pre-defined and unchanging PIN. This can be read off by means of an inscription or QR code or can be available in the handbook for the device. This variant also has only a low level of security.

Due to the low level of security, both alternative mechanisms are disadvantageous in an industrial environment.

### SUMMARY

Teachings of the present disclosure include systems and methods for the pairing which offers an improved level of security with such devices that do not have sufficient displays and input capabilities. For example, some embodiments of the teachings herein include a device (11, 31), having: an interface (17, 34) for a wireless data connection, a controllable signal facility (13, 33) for generating an optical or acoustic signal, and a control facility (14) for the interface (17, 34) and for the controllable signal facility (13, 33), wherein the control facility (14) is configured, for the acquisition of a data connection to a second device (12, 32), to carry out a PIN exchange method which comprises: generating (21) and storing a PIN for this acquisition of a data connection, emitting (22) the PIN with the signal facility (13, 33) in order to enable the reception by the second device (12, 32), return reception (33) of the PIN from the second device (12, 32) via the wireless data connection, and acquisition of the data connection only when the received PIN matches the stored PIN.

In some embodiments, for each acquisition of a data connection, a new PIN is generated with a method for random number generation.

In some embodiments, the signal facility (13, 33) is a light-emitting diode (13).

In some embodiments, the signal facility (13) comprises a plurality of light-emitting diodes, in particular is an RGB LED (33).

In some embodiments, the signal facility (13, 33) is a loudspeaker.

In some embodiments, the control facility (17, 34) is configured to encrypt the PIN before the transmission, in particular with a private key for a PGP method, and to carry out the reception of the PIN in a decrypted form.

In some embodiments, the control facility (14) is configured to convert the PIN, by means of an inverse fast Fourier transform, into a discrete-time representation and to actuate the signal facility (13, 33) on the basis of the result of the conversion.

In some embodiments, the control facility (14) is configured to transfer a checksum together with the PIN.

As another example, some embodiments include a device (12, 32) having: an interface (18, 35) for a wireless data connection, an optical or acoustic detector (15, 36), and a control facility (16) for the interface (18, 35) and for the detector (15, 36), wherein the control facility (16) is configured, for the acquisition of a data connection to a second device (11, 31), to carry out a PIN exchange method which comprises: receiving a PIN for this acquisition of a data connection from the second device (11, 31) by means of the detector (15, 36), and return transmission of the PIN to the second device (11, 31) via the wireless data connection.

In some embodiments, the control facility (16) is configured to convert the signal received by the detector (15, 36) into the PIN by means of a fast Fourier transform.

In some embodiments, the control facility (16) is configured to receive a checksum together with the PIN and, on the basis of the checksum, to establish whether the PIN has been transferred error-free.

In some embodiments, the wireless data connection is a connection in accordance with the Bluetooth standard.

In some embodiments, the wireless data connection is a connection in accordance with the WiFi standard.

As another example, some embodiments include a method for establishing a wireless data connection between a first and a second device (11, 12, 31, 32), wherein a PIN exchange method is carried out, in which: the first device (11, 31) generates and stores a PIN, the first device (11, 31) transfers the PIN optically or acoustically to the second device (12, 32), the second device (12, 32) receives the PIN optically or acoustically, the second device (12, 32) transfers the PIN to the first device (11, 31) by means of the wireless data connection, and the connection is only acquired if the stored PIN matches the PIN received at the first device (11, 31) by means of the wireless connection.

### BRIEF DESCRIPTION OF THE DRAWINGS

The teachings of the present disclosure are further described and explained in greater detail making reference to the exemplary embodiments illustrated in the drawings. In the drawings:

FIG. 1 shows a sensor and a control system which acquire a Bluetooth connection incorporating teachings of the present disclosure;

FIG. 2 shows schematically a method for secure Bluetooth pairing incorporating teachings of the present disclosure; and

FIG. 3 shows a circuit breaker and a tablet PC, which acquire a WiFi connection incorporating teachings of the present disclosure.

### DETAILED DESCRIPTION

Some of the embodiments include a device with an interface for a wireless data connection, a controllable signal facility for generating an optical or acoustic signal, and a control facility for the interface and for the controllable signal facility. The control facility is therein configured, for the acquisition of a data connection to a second device, to carry out a PIN exchange method which comprises:
generating and storing a PIN for this acquisition of a data connection,
transmitting the PIN with the signal facility in order to enable the reception by the second device,
return reception of the PIN from the second device or the wireless data connection,
acquisition of the data connection only when the received PIN matches the stored PIN.

In some embodiments, the device includes an interface for a wireless data connection, an optical or acoustic detector and a control facility for the interface and for the detector. The control facility is therein configured, for the acquisition of a data connection to a second device, to carry out a PIN exchange method which comprises:
receiving a PIN for this acquisition of a data connection from the second device by means of the detector,
return-transmitting the PIN to the second device via the wireless data connection.

The first and second devices described in this way act together, each as both transmitter and receiver of the PIN. In the methods for establishing a wireless data connection between a first and a second device, a PIN exchange method is carried out. Therein, the first device generates and stores a PIN and transfers the PIN optically or acoustically to the second device. The second device receives the PIN optically or acoustically and transfers the PIN back to the first device by means of the wireless data connection. The wireless data connection is only acquired if the stored PIN corresponds to the PIN received at the first device by means of the wireless connection. With the devices and the methods, for transmission with the signal facility a data channel is used which is, firstly, not a radio channel and, secondly, is already present in many devices. By this means, the procedure can be easily used on existing devices.

For the first device, which generates the PIN, an acquisition of the data connection takes place substantially more securely with precisely that second device which is provided for this purpose in that the optical or acoustic signal facility is brought into the vicinity of this second device. The acquisition of such a connection in a malicious manner by third-party devices is made more difficult since it is more difficult for the third-party devices to receive the transfer of the PIN by an optical or acoustic route than by the radio-based wireless data connection.

A PIN (personal identification number) is herein to be understood, in the normal way, to be a character sequence, typically a sequence of digits, of an arbitrary number of characters.

The reception of the return-transmitted PIN in the first device therein takes place via the wireless data connection. This is always possible, even if the desired data connection does not even exist yet and it is the reception of the PIN that provides the pre-condition for it. The acquisition of the data connection should be understood to mean that the devices accept and process data physically received from one another beyond the PIN exchange method. If, however, the data connection does not come about, for example because the return-transmitted PIN was incorrect, although both devices physically receive the transmissions from the respective other device, they do not process them further than to ascertain that no connection to the other device exists.

In some embodiments, the control facility can be configured, for each acquisition of a data connection, to generate a new PIN with a method for random number generation. By this means it is ensured that no security risk arises from an already existing, stored PIN. Such PINs can become known and utilized from the time at which they are made known, so that a connection acquisition by way of third-party devices can be carried out in such a way as if the third-party devices corresponded to the second device, i.e. the device which receives the PIN optically or acoustically.

In some embodiments, the signal facility can be a light-emitting diode. Light-emitting diodes are small, inexpensive and low-consumption and are therefore widely used in small and large devices to display simple signals. Such signals are, for example, an illumination for the operational readiness of the device or for a low charge level of a battery. For many applications, a control system which can also generate temporally varying signals such as flashing already exists for this. Light-emitting diodes are also very quick to react and can therefore also indicate temporally high-resolution signals. They are therefore particularly suitable for the transference of a PIN as invisibly and rapidly as possible. The PIN can therein be encoded, for example, by way of values for brightness variation and switching duration.

In some embodiments, the signal facility can comprise a plurality of light-emitting diodes, in particular an RGB LED. RGB LEDs are often built into both small and large devices in order to output signals regarding the operating state thereof. With a multicolored LED, a relatively complex modulation of the signal can be undertaken that is more difficult to decrypt. It is also possible to transfer more rapidly a relatively long representation of the PIN which appears, for example, following an encryption. In addition to the brightness variation and the switching duration of individual LEDs, relative values between the LEDs can also be used for encoding the PIN.

In some embodiments, the signal facility can also be a loudspeaker. Loudspeakers are also present in many small devices and are able to modulate the sound generated in such a way that a data transfer can be undertaken. For example, the loudspeaker can be a piezo loudspeaker.

In some embodiments, the control facility can be configured to encrypt the PIN before the transmission, in particular with a private key for a PGP method and to carry out the reception of the PIN in a decrypted form. By means of the use of an encryption method, the security of the client device can be further increased. A third-party device that intends maliciously to acquire a data connection with the device must be able to undertake the decryption. If, for the encryption, for example, a private key of a PGP method is used, for this purpose, a third-party device must know the public key.

The acquisition of the data connection is herein suitably interrupted if the PIN is transmitted back in a non-decrypted manner. If the PIN is therefore only sent back in the encrypted form, which is readily possible, no connection comes into existence. It is ensured in this way that only a second device which can decrypt the PIN, that is, for example, possesses the public key, can acquire the data connection with the device.

In some embodiments, the control facility can be configured to convert the PIN into a discrete-time representation by means of an inverse fast Fourier transform and to actuate the signal facility on the basis of the result of the conversion. In some embodiments, other forms of the conversion of the PIN into the actuation of the signal facility can be used. For example, the actuation can take place in the manner of a morse code.

In some embodiments, in the second device, the control facility can be configured to convert the signal received by the detector into the PIN by means of a fast Fourier transform.

In some embodiments, the control facility can further be configured to transfer a checksum together with the PIN. The checksum enables the receiving device to ascertain whether the transfer of the PIN has taken place error-free.

In some embodiments, in the second device, the control facility is then suitably configured to receive a checksum together with the PIN and, on the basis of the checksum, to establish whether the PIN has been transferred error-free.

If the PIN has not been transferred error-free, it can be signaled that a renewed transfer is to be carried out. In some embodiments, the first device can also be configured to carry out the emission of the PIN multiple times anyway. In this case, the second device can reject a falsely received PIN and receive the PIN again.

In some embodiments, the wireless data connection can be a connection according to the Bluetooth standard. Bluetooth connections are widespread, including in the industrial domain. In suitably equipped devices, the acquisition of a Bluetooth data connection, also called pairing, comprises a PIN exchange in which a user inputs the PIN in one of the devices. By contrast, devices which do not support such a process operate without a PIN or with a factory pre-set PIN.

In some embodiments, the wireless data connection can also be a connection in accordance with the WiFi standard. With this type of data connection also, it is advantageous if the PIN is emitted via the signal facility in order to make a connection acquisition by simple devices more secure.

The following exemplary embodiments describe the method on the basis of the pairing of two Bluetooth-capable devices. However, this is merely an example and the teachings of the present disclosure can be used just as readily for other types of wireless data connection, for example WiFi. In some embodiments, it is used in conjunction with radio standards. Radio standards are considered to be those which use frequencies in the MHz to GHz range.

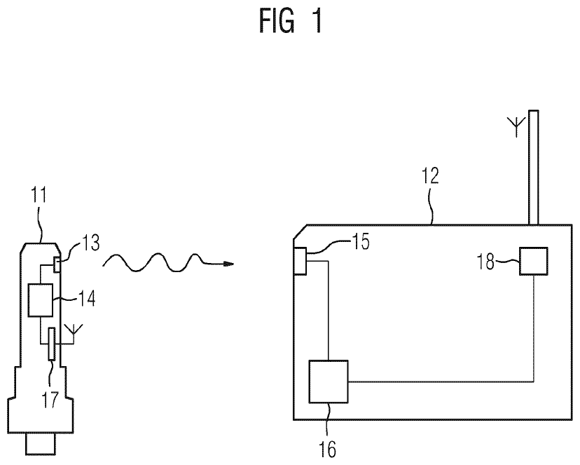

FIG. 1 shows a first example device which, in this case, is an industrial sensor 11 incorporating teachings of the present disclosure. FIG. 1 also shows a second device which, in this case, is an industrial control system 12 incorporating teachings of the present disclosure. The control system 12 is configured to address, control and read a large number of sensors 11 wirelessly. The control system 12 can be provided, for example, in a factory building or a production plant.

In some embodiments, the second device can also be a device which creates a connection to other networks, for example to a data network such as the Internet, and via this for example to a cloud service. The device can herein correspond in its function to a router that is equipped for a Bluetooth connection.

The sensor 11 is therefore to be connected wirelessly, in this example via Bluetooth, to the control system 12. As a relatively small device, the sensor 11 has no keyboard or other input capabilities. Similarly, the sensor 11 lacks a screen for the output of information. A pairing method in which a PIN is generated and displayed on one of the devices and in which the input must be made on the other device cannot be carried out with the sensor 11.

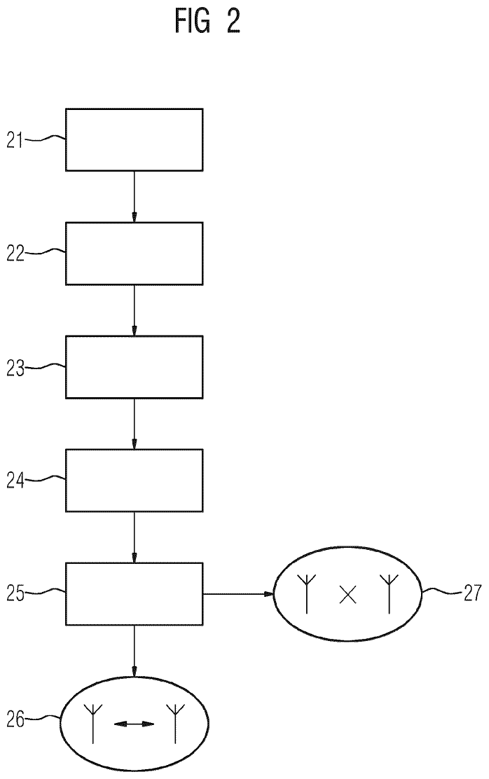

However, the sensor 11 has an infrared LED 13 which is actuated and modulated by the microcontroller 14 installed in the sensor 11. If a pairing is now to take place in which the sensor 11 is connected by Bluetooth to the control system 12 for the data exchange, then a PIN exchange method which uses this infrared LED 13 is carried out. The PIN exchange method is represented schematically in FIG. 2.

In the PIN exchange method, in a first step 21, a new PIN is generated by the microcontroller 14. In principle, the PIN can be any sequence of symbols, for example an alphanumeric character sequence or simply a numerical sequence. The generating takes place by way of a method for generating random numbers. Such methods are also known from computer technology, like the methods and means of placing the generated PIN in the memory store of the microcontroller 14. The PIN is placed in intermediate storage for a later comparison.

The PIN generated in this way is emitted in a second step 22 with the infrared LED 13. In order to do this, for example, an inverse fast Fourier transform (IFFT) can be used in order to generate a modulation sequence for the infrared LED 13 from the PIN. The infrared LED 13 actuated by the microcontroller 14 is controlled such that the modulation sequence is run through once or a plurality of times. The infrared LED 13 has its brightness as the only degree of freedom, although this can be modulated very rapidly and thereby emit a complex data sequence.

In some embodiments, in place of an IFFT, another form of the conversion of the PIN into a brightness sequence can also be used. For example, a sequence of discrete brightnesses can be used. In the simplest case, this corresponds to a Morse code while, in more complex variants, more than two brightness levels can be used. In this way, the data transfer can be made, firstly, quicker but also, secondly, more complex. Herein, it can be an aim to make the PIN as difficult as possible for third parties to read out. For this purpose, the conversion of the PIN into the brightness sequence can be made more complex than would be needed for the pure transfer of data.

In some embodiments, the in addition to the PIN, a checksum is transferred on the basis of which the correct reception can be checked. Checksums are known from the prior art.

The infrared signal emitted in this way is received by the control system 12 with an infrared detector 15 in a third step 23. A microcontroller 16 of the control system 12 establishes the PIN from the received signal, for example by means of a fast Fourier transform (FFT). The PIN is thus transferred by the sensor 11 to the control system 12 by optical means.

In some embodiments, the sensor 11 is in the vicinity of the control system 12 when the pairing is to take place. In some embodiments, the infrared LED 13 is configured such that a good reception by the infrared detector 15 is possible. In contrast to radio signals which can readily penetrate walls, depending upon their construction, the infrared signal can hardly be received outside a room and, depending upon its strength, beyond the direct line of sight.

In a fourth step 24, the control system 12 now uses Bluetooth in order to transfer the PIN back to the sensor 11. The requirements for spatial closeness or line-of-sight are therein substantially less than for optical transfer.

The sensor 11 receives the PIN in a fifth step 25 and compares the PIN received in this way with the originally transmitted PIN which was stored by the sensor 11. If they match, then the sensor 11 accepts the connection. Thus in a sixth step 26, a Bluetooth connection can be created between the sensor 11 and the control system 12. If, however, the PIN does not correspond or if it is not contained in the return transmission, the sensor 11 refuses the connection in a seventh step 27.

Therefore, in contrast to a connection acquisition with an established PIN which is possibly also the same for all the sensors of the type of the sensor 11 or even with no PIN, the connection acquisition is therefore herein secured by a newly created PIN for each pairing. This PIN is transferred between the devices by simple means, in this case by infrared LED 13 and infrared detector 15, which is significantly more difficult to tap into than a transfer by Bluetooth itself.

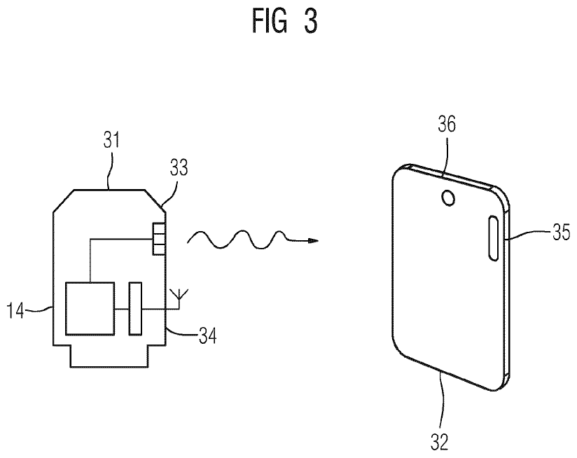

FIG. 3 shows a second exemplary embodiment. Similar components are herein provided with the same reference signs as in FIG. 1. FIG. 3 shows a first device which, in this case, is a circuit breaker 31. FIG. 1 also shows a second device which, in this case, is a tablet PC 32. In a similar way, the second device can also be a smartphone. The circuit breaker 31 is installed in an industrial environment. For example, this can be a DC switch in a factory DC installation. Both devices are configured for a wireless data connection with a respective WiFi interface 34, 35.

A WiFi connection is to be generated between the circuit breaker 31 and the tablet PC 32. In this exemplary embodiment, the circuit breaker 31 is to have no display and no adequate capability for the input of a PIN.

However, the circuit breaker 31 comprises an RGB LED 33 for a status display, which is actuated and modulated by the microcontroller 14 installed in the circuit breaker 31. If a connection acquisition is to take place now between the circuit breaker 31 and the tablet PC 32, then the PIN exchange method introduced in relation to FIG. 2 is again carried out. In this case, the PIN is emitted by means of the RGB LED 33. Therein, a more complex modulation can be undertaken with the three individual diodes that form the RGB LED 33 than is possible with a single LED. Herein, the modulation can itself be undertaken in such a way that it makes it as difficult as possible for outsiders to recognize the manner of the modulation. The reception of the PIN takes place, in the case of the tablet PC 32, by means of the camera 36 installed in the tablet PC 32. If this is an active pixel sensor, as is often found in smartphones (also known as a CMOS sensor, in contrast to the CCDs used in digital cameras and video cameras), a relatively rapid modulation can be detected. The return transfer of the PIN from the tablet PC 32 to the circuit breaker 31 takes place, similarly to the first exemplary embodiment, by means of the WiFi interfaces 34, 35.

### REFERENCE SIGNS

11 Sensor
12 Control system
13 Infrared LED
14, 16 Microcontroller
15 Infrared detector
17, 18 Bluetooth interface
21 . . . 27 First to seventh step
31 Circuit breaker
32 Tablet PC
33 RGB LED
34, 35 WiFi interface
36 Camera

What is claimed is:

1. A device 14 comprising:
an interface for wireless data connection;
a controllable signal facility to generate an optical or acoustic signal; and
a control facility for the interface and for the controllable signal facility;
wherein the control facility, to acquire a data connection to a second device carries out a PIN exchange method comprising:
generating and storing a PIN for data connection;
emitting the PIN with the signal facility to enable reception by the second device;
return reception of the PIN from the second device via the wireless data connection; and
acquisition of the data connection only when the received PIN matches the stored PIN.

2. The device as claimed in claim 1, wherein the PIN is generated by random number generation.

3. The device as claimed in claim 1, wherein the signal facility comprises a light-emitting diode.

4. The device as claimed in claim 3, wherein the signal facility comprises a plurality of light-emitting diodes.

5. The device as claimed in claim 1, wherein the signal facility comprises a loudspeaker.

6. The device as claimed in claim 1, wherein the control facility encrypts the PIN before the transmission, and carries out the reception of the PIN in a decrypted form.

7. The device as claimed in claim 1, wherein the control facility converts the PIN using an inverse fast Fourier transform, into a discrete-time representation and actuate the signal facility based on the conversion.

8. The device as claimed in claim 1, wherein the control facility transfers a checksum together with the PIN.

9. A device comprising:
an interface for wireless data connection;
optical or acoustic detector;
a control facility for the interface and the detector;
wherein the control facility is configured, for acquisition of a data connection to a second device to carry out a PIN exchange method including:
receiving a PIN for acquisition of a data connection from the second device using the detector; and
return transmission of the PIN to the second device via the wireless data connection.

10. The device as claimed in claim 9, wherein the control facility converts the signal received by the detector into the PIN using a fast Fourier transform.

11. The device as claimed in claim 9, wherein the control facility receives a checksum together with the PIN and, on the basis of the checksum, establish whether the PIN has been transferred error-free.

12. The device as claimed in claim 9, wherein the wireless data connection comprises a Bluetooth standard connection.

13. The device as claimed in claim 9, wherein the wireless data connection comprises a standard WiFi connection.

14. A method for establishing a wireless data connection between a first device and a second device, the method comprising:
generating and storing a PIN with the first device (11, 31) generates and stores a PIN;
transferring the PIN from the first device optically or acoustically to the second device;
receiving the PIN at the second device;
transferring the BIN from the second device to the first device using of the wireless data connection; and
acquiring the connection only if the stored PIN matches the PIN received at the first device.
